(19) United States
(12) Patent Application Publication
(10) Pub. No.: US 2025/0316715 A1
(43) Pub. Date: Oct. 9, 2025

(54) 3D ELECTRODES AND FLOW STRUCTURES FOR HIGH PERFORMING HYBRID REDOX FLOW BATTERIES

(71) Applicant: Lawrence Livermore National Security, LLC, Livermore, CA (US)

(72) Inventors: Swetha Chandrasekaran, Livermore, CA (US); Anna Nikolaevna Ivanovskaya, Mountain VIew, CA (US); Buddhinie Srimali Jayathilake, Tracy, CA (US)

(21) Appl. No.: 18/629,646

(22) Filed: Apr. 8, 2024

(51) Int. Cl. H01M 4/86; H01M 8/18

(52) U.S. Cl. CPC H01M 4/8626; H01M 8/188

(57) ABSTRACT

A redox flow battery apparatus includes a membrane, a flow plate, and a porous electrode positioned between the membrane and the flow plate. The porous electrode has a surface configured for a reversible metal deposition thereon from a metal ion electrolyte solution flowing through the porous electrode. The porous electrode has a predefined porosity configured to allow the flowing of the metal ion electrolyte solution through the porous electrode.

This invention was made with Government support under Contract No. DE-AC52-07NA27344 awarded by the United States Department of Energy. The Government has certain rights in the invention.

### FIELD OF THE INVENTION

The present invention relates hybrid redox flow batteries, and more particularly, this invention relates to three-dimensional (3D) electrodes and flow structures for high performing hybrid redox flow batteries.

### BACKGROUND

Redox flow battery (RBF) is a promising emerging technology which enables low-cost grid-scale energy storage coupled with renewable power generation. However, the widespread deployment of the state-of-the-art vanadium redox flow battery is hindered due to high electrolyte cost. Alternatively, an iron flow battery provides key advantages. Iron is eco-friendly, being the most abundant transition metal in the Earth's crust. Moreover, electrolyte cost for iron is more than 10-fold less than the cost of vanadium. In addition, iron offers a higher energy density compared to vanadium.

| | | |
|---|---|---|
| Positive Electrode: | 2Fe²⁺ → 2Fe³⁺ + 2e⁻ | E⁰ = 0.77 V (vs. NHE) |
| Negative Electrode: | Fe²⁺ + 2e⁻ → Fe⁰ | E⁰ = −0.44 V (vs. NHE) |
| Overall Reaction: | 3Fe²⁺ → 2Fe³⁺ + Fe⁰ | ΔE⁰ = 1.21 V |

Improving electrodes for flow through batteries includes improving metal plating (charging) and metal stripping (discharging) as demonstrated in a hybrid flow battery for better performance. One of the current disadvantages of an iron flow battery include the issue that storage capacity is dependent on reversible metal deposition. Metal depositing, plating, etc. and metal stripping capacities in energy storage related applications are limited due to capacity of the electrode and flow structural features. Metal deposition can fill porous parts in the electrode structure and limit flow distribution. Moreover, other issues such as non-uniform plating, dissolution, and erosion can occur. The state-of-the-art three-dimensional (3D) technology is the use of carbon felt electrodes which shows challenges due to electrolyte flow and ion transport issues with internal clogging with metal deposition, poor reaction kinetics for metal deposition and stripping, uncontrolled bulk part dissolution during discharging process.

As illustrated in FIG. 1, crossover of Fe³⁺ through membrane separator causes self-discharge and lowers discharging capacity. Iron hydroxide precipitation on and inside membrane disrupts electrolyte flow, conductivity, and active material actualization.

The current conventional electrodes are planar electrodes or disordered foams and felts. Planar electrodes have low surface areas that limit the storage capacity of the battery. In one report, felt electrodes have included folded, lanced offset, or serrated fin 3D electrode structures with inter-digitated flow plate. Processing of carbon felts is done for zinc and iron flow battery applications. However, foams and felts do not have efficient mass transport and thus, have channeling issues and are not optimized to achieve bulk metal deposition/stripping for energy storage applications.

However, these reported electrodes do not provide variable structural features. Thus, efficient and high rate deposition and stripping of metal during charging and discharging respectively cannot be achieved. Moreover, foams and felts have inefficient mass transport, demonstrate issues with channeling, and cannot be optimized for uniform metal deposition/stripping. Previous reports are limited to applications for the aqueous to aqueous conversions. In addition, former approaches disclose only conductive components for the electrodes. Processed carbon felt can limit capacity and cause ineffective flow rates and pressure drops during the charging/discharging process.

There remains a need for electrodes that function efficiently in the iron flow battery by improving metal deposition, discharging processes, and storage capacity.

### SUMMARY

According to one embodiment, a redox flow battery apparatus includes a membrane, a flow plate, and a porous electrode positioned between the membrane and the flow plate. The porous electrode has a surface configured for a reversible metal deposition thereon from a metal ion electrolyte solution flowing through the porous electrode. The porous electrode has a predefined porosity configured to allow the flowing of the metal ion electrolyte solution through the porous electrode.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a schematic diagram of an electrochemical setup for flow batteries with deposition of metal iron on the negative electrode and potential Fe³⁺/Fe²⁺ crossover.

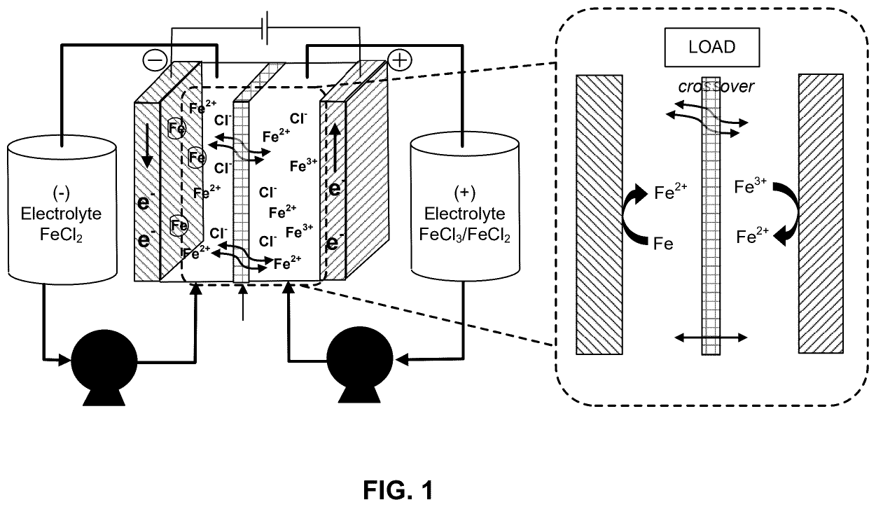

FIG. 2A is a schematic diagram of an electrochemical cell for a redox flow battery using a flow-through 3D printed electrode, according to one embodiment.

FIG. 2B is a schematic diagram of an expanded view of a redox flow battery apparatus, according to one embodiment.

FIG. 3A is a series of computer modeled drawings of electrode geometries printed using additive manufacturing techniques, according to one embodiment. Part (a) a simple cubic pattern, part (b) an octet pattern.

FIG. 3B is a series of computer modeled drawings of electrode geometries printed using additive manufacturing techniques, according to one embodiment. Each drawing has a magnified view of a portion of the geometric pattern. Part (a) a single unit cell, part (b) diamond pattern, part (c) an octet pattern, part (d) a gyroid pattern, and part (e) a cubic pattern.

FIG. 4A are images of metal deposition on electrodes, according to one embodiment. Part (a) is a felt electrode, and part (b) is a 3D printed carbon electrode.

FIG. 4B are images that show a comparison of felt electrodes with 3D printed electrodes, according to one embodiment. Part (a) a rust deposited membrane, part (b) a rust deposited felt electrode, part (c) a 3D printed electrode.

FIG. 5 includes schematic diagrams of 3D printed electrodes having different relative densities, according to one embodiment. Part (a) depicts a high density electrode, part (b) depicts a low density electrode, part (c) depicts a gradient density electrode, and part (d) depicts a printed electrode in an electrochemical cell.

FIG. 6 includes schematic diagrams of flow fields, according to one embodiment. Part (a) depicts a flow through electrode, part (b) depicts a parallel serpentine electrode, and part (c) depicts various flow field patterns.

FIG. 7A depicts combination plots of cell voltage for long term use of the electrodes, according to one embodiment. Part (a) felt electrode, part (b) 3D printed electrode, and part (c) depicts a graph of the degradation rate per cycle of felt versus 3D printed electrode.

FIG. 7B depicts combination plots of pH and cell voltage for long term use of electrodes, according to one embodiment. Part (a) felt electrode and part (b) 3D printed electrode.

FIG. 8 depicts plots of energy efficiency of felt electrodes and 3D printed electrodes, according to one embodiment.

FIG. 9 depicts a plot of electrochemical impedance of an electrochemical cell having different electrodes compared to a 3D printed electrode, according to one embodiment. Part (a) is a wide view of the plot, and part (b) is a view of a portion of the resistance scale of the plot depicted in part (a).

FIG. 10 depicts a plot of battery cycling for up to 25 cycles of an electrochemical cell having different electrodes compared to a 3D printed electrode, according to one embodiment.

FIG. 11 is a plot of capacity curves from an 8 hour-long duration cycle, comparing a felt electrode and a 3D printed electrode, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

A “nano” dimension or descriptor such as nanoscale, nanoporous, etc. is defined as having a diameter or length (e.g., a pore having an average diameter) less than 1000 nanometers (nm). A “micro” dimension or descriptor such as microscale, microporous, micron-sized, etc. is defined as having a diameter or length (e.g., a pore having an average diameter) less than about 1000 microns (μm).

It is also noted that, as used in the specification and the appended claims, wt. % is defined as the percentage of weight of a particular component relative to the total weight/mass of the mixture. Vol. % is defined as the percentage of volume of a particular compound relative to the total volume of the mixture or compound. Mol. % is defined as the percentage of moles of a particular component relative to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The following description discloses several preferred embodiments of hybrid redox flow batteries and/or related systems and methods.

In one general embodiment, a redox flow battery apparatus includes a membrane, a flow plate, and a porous electrode positioned between the membrane and the flow plate. The porous electrode has a surface configured for a reversible metal deposition thereon from a metal ion electrolyte solution flowing through the porous electrode. The porous electrode has a predefined porosity configured to allow the flowing of the metal ion electrolyte solution through the porous electrode.

A list of acronyms used in the description is provided below.
3D three-dimensional
AEM anion exchange membranes
AM additive manufacturing
DIW direct ink write
RD relative density
TPMS triply periodic minimal surface
wt. % weight percent
VE Voltaic efficiency

Metal depositing and stripping capacities in energy storage related applications are typically limited due to capacity of the electrode and flow structural features. Current conventional approaches use carbon felt electrodes, but these electrodes demonstrate challenges due to electrolyte flow and ion transport issues with internal clogging with metal deposition, poor reaction kinetics for metal deposition and stripping, uncontrolled bulk part dissolution during discharging process.

As described herein, both conductive and nonconductive porous components may be engineered, designed, and manufactured for improved metal deposition, discharging and fluid dynamics. Processed carbon felt can limit capacity and cause ineffective flow rates and pressure drops during charging/discharging process. According to one approach, the engineered structure of an electrode that promotes metal deposition thereon is critical for determining the storage capacity of the battery (amount of metal deposit on/within the electrode structure).

According to one embodiment, three-dimensional (3D) flow battery components may be engineered using additive manufacturing (AM) technologies such as advanced 3D printing for design and manufacture for the plating side of the battery. AM may also be used as a manufacturing tool to learn the structure-property features by providing a model for other different manufacturing tools to be applied to fabricate the AM-designed structures These components include conductive 3D electrodes, flow plates, and nonconductive porous components. All of these components may be designed and manufactured with variable porous structures to improve performance of the metal deposition and discharging processes and storage capacity.

According to one embodiment, both conductive and non-conductive porous components may be engineered, designed and manufactured for improved metal deposition, discharging, and fluid dynamics. According to one approach, a 3D engineered electrode and flow structures may be designed and manufactured with tuned porous structures to improve the performance of the bulk metal deposition and stripping reactions. These novel electrodes may improve metal deposition and stripping capacity, as well as reaction kinetics and efficiency. A principal application of the system may include hybrid flow batteries with bulk metal plating and stripping reactions. In hybrid flow batteries, storage and discharge capacities are limited by the amount of metal deposited and stripped at the plating electrode. With engineered 3D structures, an even current distribution and an even deposition are observed. Availability of manufacturing methods allows fabrication of the 3D engineered electrode and flow structures and provides opportunities to increase hybrid redox flow battery performance.

According to one embodiment, a redox flow battery system includes an electrochemical cell including a 3D printed flow-through electrode having a predefined geometry, where the cell operates with a specific range of flow rates, variable flow rates, electrolytes, etc. A redox flow battery includes a membrane, a current collector, flow plate and a porous electrode positioned between the membrane and the flow plate. In one approach, the membrane-facing side of the porous electrode may be in direct contact with the membrane and an opposite side of the porous electrode may be in direct contact with the flow plate. In another approach, there is a space between the porous electrode and the membrane. The porous electrode has a surface that is configured for reversible metal deposition thereon from a metal ion electrolyte solution flowing through the porous electrode. The porous electrode has a predefined porosity configured to allow the flowing (e.g., mass transport) of the metal ion electrolyte solution through the porous electrode.

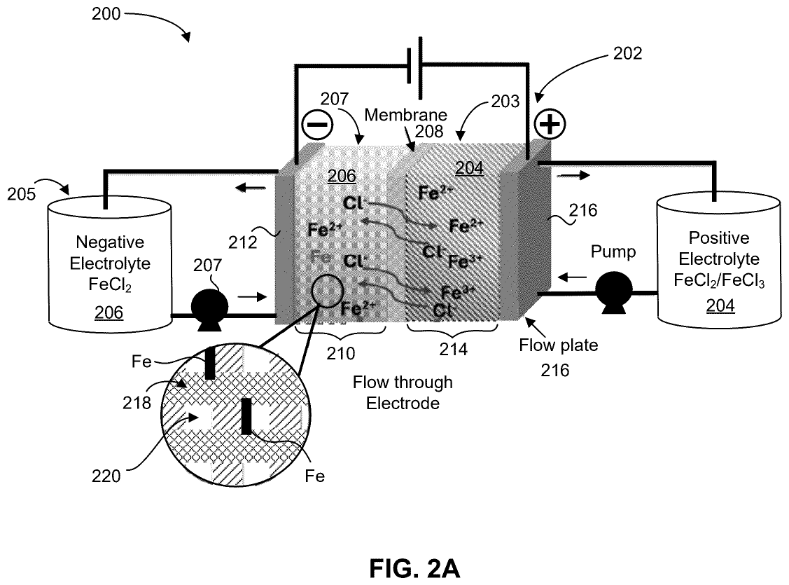

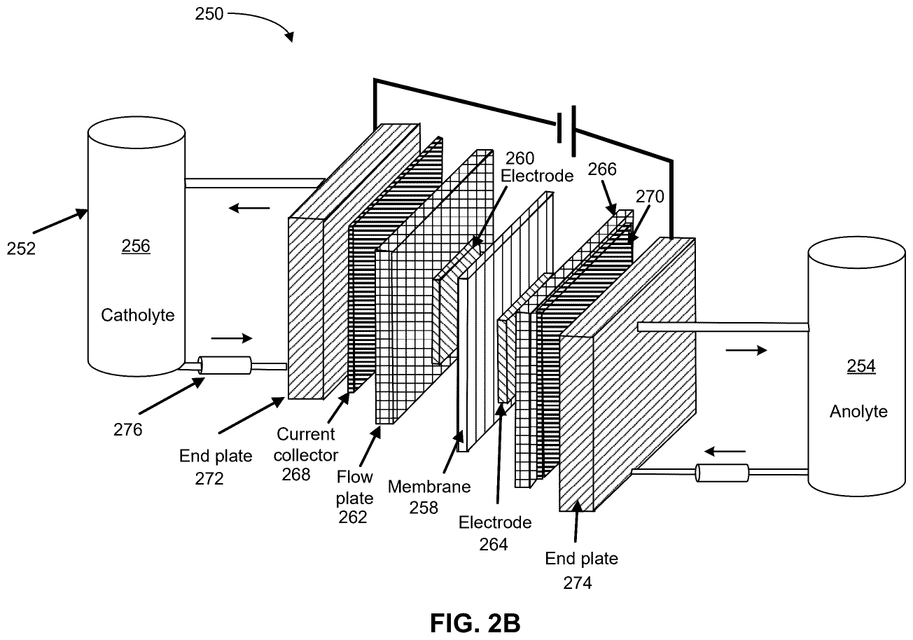

FIG. 2 depicts a redox flow battery apparatus, in accordance with one embodiment. As an option, the present redox flow battery apparatus 200 may be implemented in conjunction with features from any other embodiment listed herein, such as those described with reference to the other FIGS. Of course, however, such redox flow battery apparatus 200 and others presented herein may be used in various applications and/or in permutations which may or may not be specifically described in the illustrative embodiments listed herein. Further, the embodiments presented herein may be used in any desired environment.

FIG. 2 illustrates a schematic drawing of one example of a redox flow battery being an iron flow battery. The redox flow battery apparatus 200 includes an electrochemical chamber 202 that include an iron electrolyte solution 204, 206. Iron electrolyte solution includes a positive electrolyte solution 204 of FeCl₂/FeCl₃ (iron chloride salt is shown as an example, other metal salts could also be used) and a negative electrolyte solution 206 of FeCl₂ (iron chloride salt is shown as an example, other metal salts could also be used). A membrane 208 may be a separator between the negative electrolyte solution 206 and the positive electrolyte solution 204. As illustrated a negative porous electrode 210 is positioned between the membrane and a flow plate 212. The membrane-facing side of the negative porous electrode 210 may be in direct contact with the membrane. The opposite side of the negative porous electrode 210 may be in direct contact with the flow plate 212. The apparatus may include a pump 207 for circulating the negative electrode solution 206 to the negative porous electrode 210 from a source 205 of negative electrolyte solution.

In preferred approaches, the hybrid flow battery functions with metal deposition on the electrode during operation. The 3D printed electrode functions as a surface for metal deposition and as a structure for mass transport of the electrolyte to pass through during operation of the cell battery.

The negative porous electrode 210 has a surface configured for reversible iron deposition thereon from the iron electrolyte solution 206. As illustrated in the magnified view of a portion of the negative porous electrode 210, the surface 218 of the electrode is engineered to have a surface area conducive to iron deposition Fe. For example, during charging of the battery, iron Fe from the negative electrolyte solution 206 is deposited onto the surfaces 218 of the porous electrode 210 thereby forming layers of the Fe on the surface 218 of the porous electrode 210. As illustrated, the metal may be deposited on the surfaces of pores of the porous electrode. Preferably, the Fe deposition during charging is reversible such that during discharging, Fe is stripped from the surface 218 of the porous electrode 210. Moreover, an extent of the metal deposition (e.g., grams of iron deposited onto the electrode) may be reproducible for a plurality of consecutive cycles of charging and discharging for greater than 5 consecutive cycles.

The negative porous electrode 210 has a predefined porosity 220 configured to allow flowing of an iron electrolyte solution 206 through the porous electrode 210. Porosity is defined as the pore volume over total volume of the electrode. In one approach, porosity may be measured in terms of pore volume relative to total volume of the electrode as shown in Equation 1.

$$Porosity = ( \frac{Pore volume}{Total volume of electrode} ) \qquad Equation 1$$

Pore volume may be calculated according to the volume of liquid present in a saturated electrode, and total volume is the volume of space the structure occupies. In some approaches, the predefined porosity 220 may be within a predefined target porosity range of greater than 0.05 to less than 0.95. This range may be adjusted based on specific applications, e.g., design of different power systems may need a different range.

As illustrated in FIG. 2, a positive porous electrode 214 is positioned between the membrane 208 and a flow plate 216. The positive porous electrode 214 has a predefined porosity configured to allow the flowing of the positive electrolyte solution 204 through the positive porous electrode 214. For example, the positive porous electrode 214 is configured to allow mass transport of the positive electrolyte solution 204 through the porous electrode 214. In some approaches, the membrane-facing side of the positive porous electrode 214 may be in direct contact with the membrane 208. In other approaches, there is space between the membrane-facing side of the positive porous electrode and the membrane. In some approaches, the opposite side of the positive porous electrode is in direct contact with the second flow plate.

In one approach, the apparatus is a hybrid flow apparatus. In one approach, the engineered structure of the negative porous electrode 210 may have a different structure than the positive porous electrode 214. In another approach, the engineered structure of the negative porous electrode may have the same structure as the positive porous electrode.

FIG. 2B illustrates an expanded view of a redox flow battery 250, according to one approach. A membrane 258 may be a separator between the negative electrolyte solution, a catholyte solution 256 and the positive electrolyte solution, a anolyte solution 254. As illustrated a negative porous electrode 260 is positioned between the membrane 258 and a flow plate 262. The membrane-facing side of the negative porous electrode 260 may be in direct contact with the membrane 258. The opposite side of the negative porous electrode 260 may be in direct contact with the flow plate 262. A current collector 268 may be positioned in between the flow plate 262 and an end plate 268. The apparatus may include a pump 276 for circulating the negative electrode solution 256 to the negative porous electrode 260 from a source 252 of negative electrolyte solution.

The redox flow battery apparatus 250 includes a positive porous electrode 264 positioned between the membrane 258 and a flow plate 266. The positive porous electrode 264 has a predefined porosity configured to allow the flowing of the positive electrolyte solution 254 through the positive porous electrode 264. In some approaches, the membrane-facing side of the positive porous electrode 264 may be in direct contact with the membrane 258. The opposite side of the positive porous electrode 264 may be in direct contact with the flow plate 266. A current collector 270 may be positioned in between the flow plate 266 and an end plate 274.

In one approach, the negative electrode is designed to achieve high surface area while maintaining sufficient porosity for improved flow distribution. 3D engineered, designed and manufactured components may allow better charging/discharging performance. Moreover, analysis of membrane separator properties in an apparatus that includes the porous electrode as described herein indicates a lower self-discharge while keeping same or higher ionic conductivity.

In one approach, a redox flow battery may include an additional 3D porous structure that is nonconductive. In a preferred approach, the 3D porous electrode being electrically conductive, the additional 3D porous structure may be positioned between the membrane and the 3D conductive porous electrode.

According to one approach, the structure of electrodes is also important to achieve efficient mass transport under dynamic conditions associated with metal deposition. Calculations of mass transportation and position rates allow assessment of porosity of the structures and how exactly fluids flow are distributed through the unit passages. A geometric design of a unit cell may optimize mass transport through the 3D printed electrode. The complex process of metal deposition may also determine the optimal structure of the unit cell in a 3D printed electrode structure.

The geometry of the 3D printed electrode may be engineered for optimal mass transportation and calculations of the geometric dimensions may consider maximum possible currents at desired flow rates (e.g., optimal flow by mass transport). The flow rate may be measured as volumetric flow rate defined as the volume of electrolyte that passes per unit time (milliliter/minute). The efficiency of mass transport influences the reaction rate, so the ability to tune the 3D geometry of the electrode structures provides an opportunity to engineer the reactor to optimize the electrode for the best performance. A combination of the engineering of the thickness of the features and geometric arrangement of the features may affect the ability to deposit metals and provide a more uniform structure that affects the cycle of battery charging and discharging.

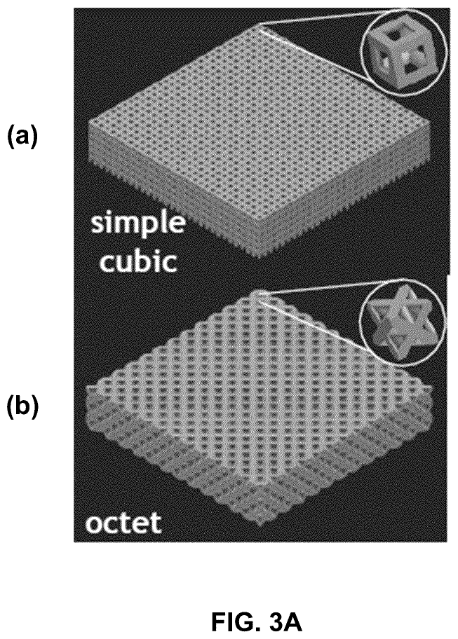

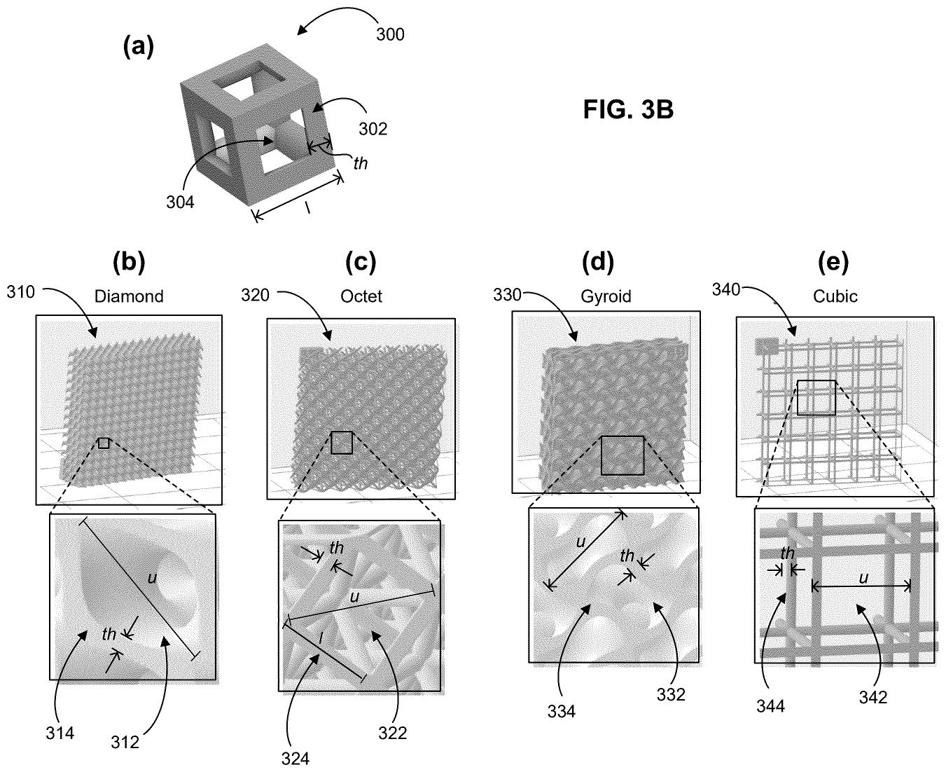

In various approaches, 3D engineered porous electrode includes an ordered structure, where the ordered structure includes repeating shape geometry. For example, a porous electrode includes a repeating shape geometry of a simple cubic unit, or an octet unit as shown in parts (a) and (b) of FIG. 3A. The simple cubic illustrated in part (a) is a face-centered cubic (fcc) structure that is based on a simple cubic structure. A fcc structure is a crystal structure that has 8 lattice points at each corner (indicating a simple cubic structure) with additional lattice points at the center of each face of the cube. In various approaches, 3D engineered electrode geometries may include the three main varieties of cubic crystal shapes: a simple cubic, a body-centered cubic (bcc), a face-centered cubic (fcc) an Iso truss, etc.

As further illustrated in FIG. 3B, 3D engineered electrode geometries may also include repeating units of shape geometries such as diamond, octet, triply periodic minimal surface (TPMS) such as a gyroid, and cubic. As illustrated in part (a), a unit cell 300 includes geometric arrangement of filaments 302 that represent a series of walls of the unit cell 300. Each wall 302 has a wall thickness th that is an average diameter of the filament 302. The void 304 inside the unit cell 300 that is defined by the geometric arrangement of filaments 302 is defined as a pore. In one approach, an electrode having a single layer of repeating cells 300 may have a width of the electrode that is the length l of at least one dimension of the cell.

The magnified view of a unit u of a series of geometries illustrates the intricate patterns for flow that may be designed and engineered. The unit are formed from a geometric arrangement of filaments, features, struts, ligaments, etc. These illustrations are by way of example only and are not meant to be limiting in any way. Each of the complex geometric structures are fabricated from a repeating unit structure. Part (b) illustrates a diamond structure 310 that includes repeating diamond units 312, as illustrated in the magnified view, formed from a geometric arrangement of filaments 314. Part (c) illustrates an octet structure 320 that includes repeating octet units 322, as illustrated in the magnified view, formed from a geometric arrangement of features 324. Part (d) illustrates a gyroid structure 330 that includes repeating minimal surface units, such as a gyroid unit 332 formed from a geometric arrangement of features 334. Part (e) illustrates a simple cubic structure 340 that includes repeating cubic units 342 formed form a geometric arrangement of features 344.

The diameter u of each unit (i.e., unit size) may be in a range of 100 nm to about 100 mm, and may be smaller or larger. A diameter u may be measured along a direction of the distance between distal points of the unit. For example, a diameter u of a diamond unit 312 may be measured along a direction between distal points of the unit 312. A diameter u of an octet unit 322 may be measured along a direction between distal points that represent a diagonal of the octet unit 322. A diameter u of the gyroid unit 332 may be measured along a direction between distal points of the main pore of the gyroid unit 332. A diameter u of the cubic unit 342 may be measured in a direction of the distal points within a main pore of the cubic unit 342. Each unit is comprised of a geometric arrangement of filaments, struts, features, ligaments, etc. A length l of the struts, features, etc., as illustrated for the octet unit 322 may be in a range of 100 nm up to greater than 500 μm. The wall thickness th of the features may be in a range of 20 μm to a few mm. The pore size may be in a range of 100 nm up to a few mm. The engineered electrodes may be homogenized, density gradient structures.

The electrode structures may be fabricated using an additive manufacturing (AM) technique to result in a 3D printed structure. In one approach, AM may be used as a design tool to understand the structure performance, property relationship, innovate structural features, etc. of an electrode for use in the redox flow battery described herein. In some approaches, the manufacture of the designed electrode may include other fabrication processes, such as laser cutting, etching, bulk manufacturing processes that are generally well known in the art, etc. In other approaches, the manufacture of the designed electrode may include AM techniques. In one approach, the AM technique may be an extrusion based technique such as a direct ink writing (DIW) technique that forms a layered lattice structure. In another approach, the AM technique may be a projection microstereolithography technique that forms a complex geometric shape, such as an octet, a diamond, a gyroid, a cubic, a face-centered cubic, etc. structure.

TABLE 1
Technical properties for possible electrode geometries

| Unit Cell | Simple | Face center | | | |
|---|---|---|---|---|---|
| Geometry | cubic | cubic | Octet | Diamond | Gyroid |
| Surface Area | 198.74 | 123.86 | 200.85 | 106.52 | 116.43 |
| (cm²) | | | | | |
| Surface Area per | 23.17 | 39.63 | 23.42 | 39.7 | 41.9 |
| Volume (cm⁻¹) | | | | | |
| Porosity | 0.49 | 0.60 | 0.50 | 0.55 | 0.50 |
| Predicted Iron | 10.02 | 11.76 | 9.37 | 10.88 | 9.70 |
| Plating (g) | | | | | |

In one example, Table 1 lists the technical properties of 3D printed electrodes having predefined unit cell geometry. The simple cubic geometry (see part (a) of FIG. 3A) and octet geometry (see part (b) of FIG. 3A) have similar surface area, surface area/volume and porosity compared to the face-centered cubic geometry.

According to one embodiment, during charging of the battery, metal from the metal ion electrolyte of the flow battery is deposited onto the surfaces of pores of the 3D printed electrode thereby forming layers of the metal on the surface of the 3D printed electrode. Preferably, metal deposition is reversible such that after charging, metal is stripped from the surface of pores of the porous electrode during discharging.

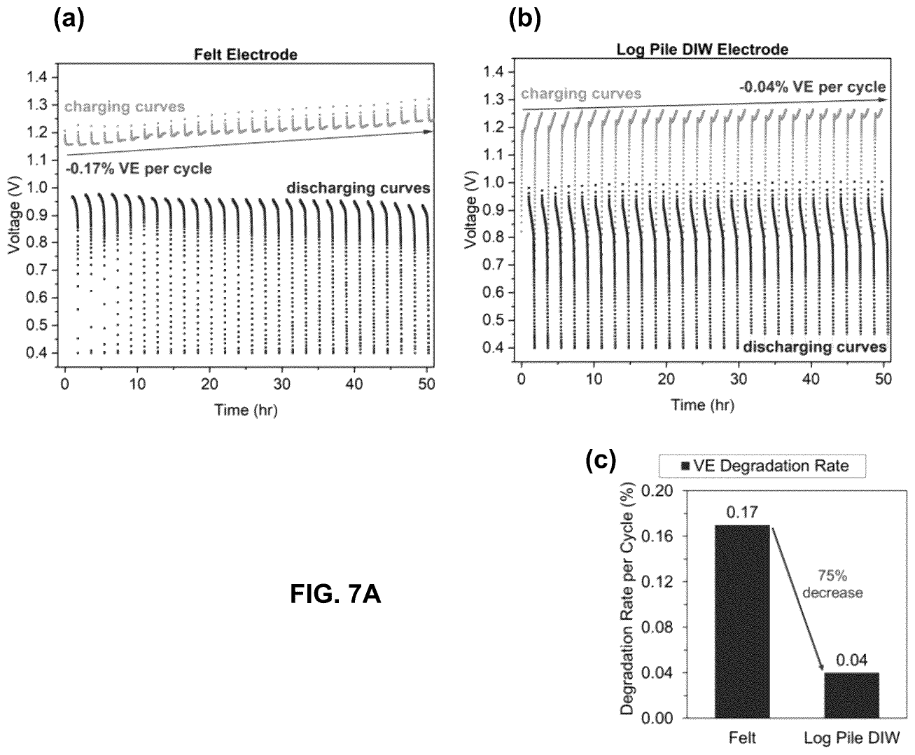

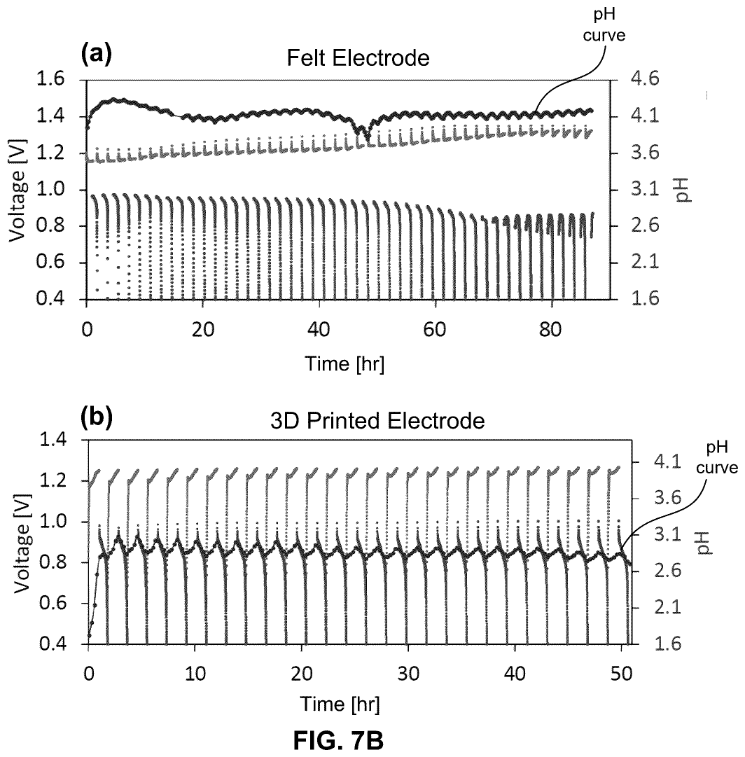

Moreover, one possible outcome is improved stability (voltaic efficiency, discharge capacity) during battery operation over at least 50 consecutive cycles (see FIGS. 7A-7B). Optimizing the system for efficient charging and discharging includes experimental analysis of 10, 20, 100 consecutive cycles. In preferred approaches, the redox flow battery maintains optimized metal deposition for greater than 1000 cycles, 10,000 cycles, 25,000 cycles, etc. In an exemplary approach, the cyclability of the redox flow battery is greater than 25,000 cycles. The consecutive cycles may be consecutive identical cycles of charging and discharging. For example, the consecutive cycles may be from completely discharged to full charged, 90% discharged to 90% charged, 80% discharged to 80% charged, etc. For example, the porous electrode maintains structural integrity following at least 5 consecutive cycles, at least 20 consecutive cycles, at least 50 consecutive cycles, at least 100 consecutive cycles or a number where the extent is no longer reproducible. The reproducibility of the cycles of deposition of metal and stripping the metal from the electrode may be determined for a particular embodiment via routine experimentation by one skilled in the art after reading the present disclosure.

In one approach, the porous electrode may be configured to exhibit in a reversible bulk metal deposition up to 7.5 g/cm³ of total volume of electrode during charging (e.g., up to fully charged) and stripping of about 98% of the deposited metal during discharging, preferably stripping of about 100% of the deposited metal (e.g., down to fully discharged). For example, for a 5 cm² porous electrode with 0.5 cm height in a redox flow battery, a porous electrode may exhibit a bulk metal deposition of 14.5 g during charging. In another example, a redox flow battery as described herein causes an iron deposition of about 10 g on a negative porous electrode during charging and then during discharging, greater than 9.8 g of iron is stripped from the negative porous electrode.

Moreover, according to various approaches, erosion is minimized, where erosion includes undesirable metal cluster detachment. Metal deposition is minimized on and within a membrane separator by engineering non-conductive features within 3D electrodes (e.g., next to the membrane).

The increasing number of metal layers on the 3D printed electrode affects current distribution of the electrode, configuration of the mass transport, flow rate, etc. The 3D printed electrode may be engineered according to a predefined geometric arrangement of features in order to optimize capacity of metal deposition and mass transport of electrolyte. The structure may be engineered to facilitate an interplay between the porosity and the surface area. For example, in one approach, in an iron redox flow battery, a high surface may be better for efficiency of the current and the porosity to allow deposition of iron on the electrode structure. However, it is not preferable to compromise efficiency to get higher capacity of iron on the electrode.

According to one approach, a 3D printed electrode may be fabricated from a conductive material that is stable in the metal ion electrolyte. In one approach, a material may be a titanium based materials, used as an ink for DIW or in combination with a polymer for lithography printing. In some approaches, a material may include one of the following metals: titanium, stainless steel, copper, zinc, etc.

In some approaches, the material of the electrode may be fabricated from carbon. In one approach, a carbon porous electrode may be engineered using methodology disclosed in U.S. patent application Ser. No. 17/692,870, which is herein incorporated by reference. For direct ink writing, a carbon-based ink is used to print the 3D structure. For the lithography-based techniques, a polymer resin is used to form a structure and then the formed structure is carbonized to result in a conductive material. In some approaches, the composition of the material comprising the negative porous electrode and the positive porous electrode may be the same or different.

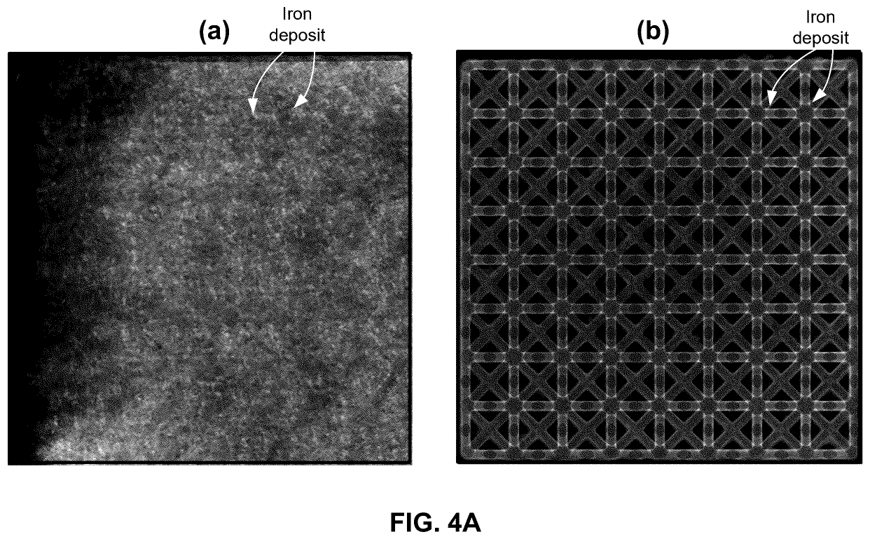

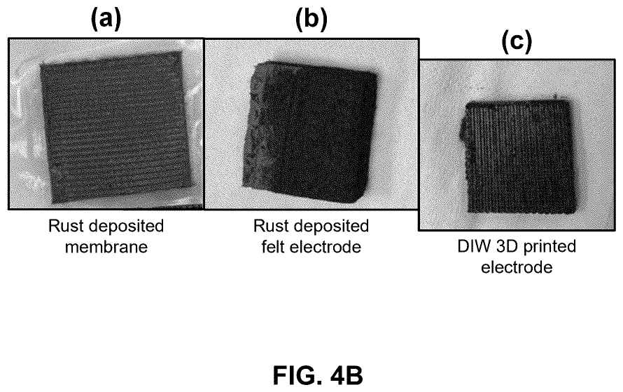

In one example, deposition of metal, e.g., iron, is illustrated in two different electrodes in FIG. 4A. Micro computed tomography (CT) images of a felt electrode in part (a) and a 3D printed cubic (FCC) electrode in part (b) illustrate deposition of iron. The dark portions of the 3D printed electrode represent the carbon structure and the light portions represent deposition of iron. The uneven distribution of iron deposit on felt electrode verifies that there are issues with fluid distribution and current distribution compared to the 3D printed electrode that demonstrates a uniform distribution of iron.

Preferably, the material of the porous electrode is capable of plating iron during a charging step, and during discharging the material remains intact and does not deteriorate during the discharging step. For example, an electrode comprised of a carbon material is stable and does not discharge during the discharging step. In sharp contrast, aluminum is not stable in acid and does not perform well then during dissolution of the plated iron on the aluminum, the aluminum material is susceptible to dissolution. In another approach, nickel may be an unstable material for iron battery discharging. Acid stable stainless steel may be a potential candidate to be used as a material for a 3D printed electrode.

In some approaches, another limiting factor during charging is loss of electrode porosity and electrolyte flowing due to increasing the deposition of iron on the electrode where the iron layers become too thick (e.g., porosity of iron deposited electrode may become less than 0.05%). When porosity decreases additional energy may be lost with additional pumping pressure.

In some approaches, preferably the electrode material is stable in the chemistry of the discharging step (e.g., stripping metal from the electrode). The material is stable in the electrolyte, for example, stable in the presence of mild to strong acids that may be involved in an electrochemical reaction. Discharging includes using the energy stored in the battery (after charging). Electrical energy storage in form of redox chemicals (including metal deposition) is charging. Discharging utilizes stored energy for power supply by converting chemicals to different redox states. During discharging of the battery, metal iron (electrochemically deposited during charging) on the negative electrode will be electrochemically stripped off. This process generates metal ions (e.g., Fe²⁺) that are recirculated through the cell to the negative electrolyte tank. Counter ions move across the membrane to balance the positive charge of metal ions in the negative compartment.

In some approaches, the porous electrode is configured to operate long-term to achieve a predefined level of storage capacity across at least 10 consecutive cycles of charging and discharging. In some approaches, a predefined level of storage capacity is achieved across at least 100 consecutive cycles, across 1000 consecutive cycles, across 10,000 cycles, across 25,000 cycles, etc. of battery cycling. Each cycle includes charging and discharging steps, e.g., a discharge of at least 80%, at least 90%, and up to 100%. Alternatively, a cycle may include charging for a 10+ hour capacity, and discharging for the same or different amounts of time.

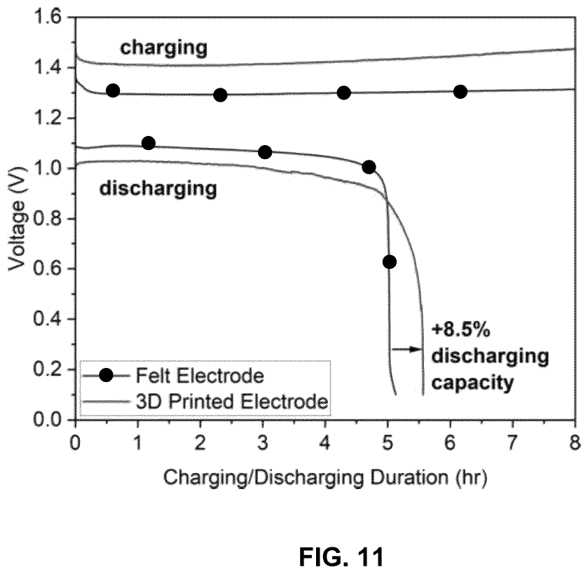

A predefined level of storage capacity may be defined as a maximum level to at least 80% state of the charge. In a preferred approach, a level of storage capacity is defined as a maximum level up to 100% state of the charge. Storage capacity may be measured as hours of discharging capacity, e.g., 10 hours. For example, as described herein, advanced manufacturing technologies may be used to fabricate electrode structures with tunable porosities to achieve 10+ hours of storage duration. Additively manufactured 3D porous electrodes may be fabricated to achieve at least >8.5% higher discharging capacity, compared to conventional felt electrodes (see FIG. 11), by improving transport and structural properties of the plating electrode. Optimization of different aspects of flow battery apparatus may enable higher discharging capacities.

In one approach, an anion exchange membranes (AEM) membrane is positioned to separate the positive electrolyte side and the negative electrolyte side with chloride exchanging between the two sides. In one example, a pattern of higher incidence of metal deposition and rust formation occurs on a membrane in a system that has a very high surface area electrode, such as a felt electrode. It is generally understood that the higher the surface area of the electrode, the greater the amount of both metal deposition and rust formation on the membrane. The features of the electrode that increase the surface area of the electrode may also have an impact on the recyclability in part via the rust formation on the membrane. The rust formation and recyclability of the electrode may be due to electrode issues and also the impact of the membrane durability due to the electrode. Thus, in some approaches, a different chemical compositions in the polymer composition of the membrane may be explored to prevent rust formation on the membrane.

The material of the electrode may affect the flow in the system. As in FIG. 4B, part (a) illustrates formation of rust on the membrane, and part (b) illustrates formation of rust on a conventional felt electrode in the electrolyte. Each image shows a buildup of lighter shading “rust color” on the membrane and felt electrode. The subsequent deposition and rust formation on the membrane and the felt electrode can clog the system and disrupt the flow of electrolyte causing a decrease in voltaic efficiency (VE) over time. Alternatively, a pre-printed 3D electrode does not demonstrate rust formation. Part (c) is an image of a 3D printed electrode using direct ink write (DIW) AM techniques which is an example of one method of 3D printing an electrode. Another technique of 3D printing is projection microstereolithography technique which allows printing of a more complex geometric shape.

In preferred approaches, the 3D printed flow-through electrode is optimized for metal deposition from the metal ion electrolyte solution during charging of the battery. In various approaches, the 3D printed electrode may be used in flow battery chemistries having metal deposition of zinc, copper, iron, lead, tin, etc. In one approach, a 3D printed porous electrode may be optimized for iron deposition from an iron electrolyte solution. In another approach, a 3D printed porous electrode may be optimized for zinc deposition from a zinc electrolyte solution. In yet another approach, a 3D printed porous electrode may be optimized for copper deposition from a copper electrolyte solution. In one approach, a 3D printed porous electrode may be optimized for deposition of a combination of metals form a combined ion electrolyte solution. The various optimized 3D printed porous electrodes may be the same, or may be different than each other. The electrode may be configured to function as a flow through electrode and optimized for metal deposition.

A negative electrolyte solution is suitable for metal plating and may include different types of anions: halides, sulfates, etc. In one approach, the metal ion electrolyte solution may include a metal-halide (e.g., Fe—Cl) system. In another approach, the metal ion electrolyte solution may include a metal-sulfate system.

According to one embodiment, a porous electrode may be configured to promote homogenous flow of the metal ion electrolyte solution through a majority of, and preferably at least 90% of the porous electrode. In one approach, the porous electrode promotes an even spread of electrolyte flowing through the electrode. In one approach, the electrolyte spreads out across and through the electrode at substantially the same rate. For example, the geometric design of the porous electrode promotes an even volumetric flow rate across a cross section of the porous electrode at most points along the direction of flow. In one approach, an even volumetric flow rate may represent a steady flow where the flow velocity is constant (i.e., at a constant speed in a constant direction such as circling the apparatus through the electrode and electrolyte source). In one approach, the porous electrode is configured as a flow field plate. In another approach, the apparatus may include the porous electrode and a flow field plate.

In various approaches, a redox flow battery apparatus includes a porous electrode that is engineered to maintain a flow rate (volume/over time) during multiple cycles of charging and discharging. In one approach, a redox flow battery apparatus may be configured, during charging or discharging, to maintain a flow rate of the metal ion electrolyte solution at greater than 40% of a flow rate measured at 0% charge of the redox flow battery apparatus when the redox flow apparatus is at 50% charge. The flow rate measured at 0% charge may be a design flow rate, a flow rate specified in a technical specification of the apparatus, etc. In a preferred approach, the flow rate (mL/min) of a nearly fully charged battery does not have a flow rate that is lower than 40% of the flow rate at the beginning of the charge.

The 3D printed electrodes may be engineered as electrodes having a uniform density across the length, width, and depth of the electrode structure. In other approaches, the 3D printed electrodes may be a gradient electrode where there is a density deviation (i.e., density gradient) across at least one dimension of the electrode. In one approach, the density gradient extends from one end of a dimension (e.g., length, width, and/or depth) to the opposite end of the dimension. For example, a relative density of the electrode of membrane-facing side has less relative density compared to the relative density of the electrode structure on the side of the electrode opposite the membrane-facing side. A relative density (RD) of the material is defined as a ratio of the density (mass of a unit volume of the material) of the material to the theoretical density of the material.

The features of the 3D printed electrode may be engineered according to a predefined geometric arrangement of features. In some approaches, the porous electrode is a gradient density electrode, where the electrode is comprised of units having predefined variable sizes. In one approach, a porous electrode may be engineered to have regions of differing relative density, where one region of the electrode has a relatively lower density, and another region of the electrode has a relatively higher density. In one approach, the features may be engineered to result in a high density. A region may be defined as having several units or a region may represent a larger portion of the porous electrode. The locations of the regions, as well as their relative density, may be predefined according to the application of the electrode to provide benefit of the location of the higher relative density or lower relative density.

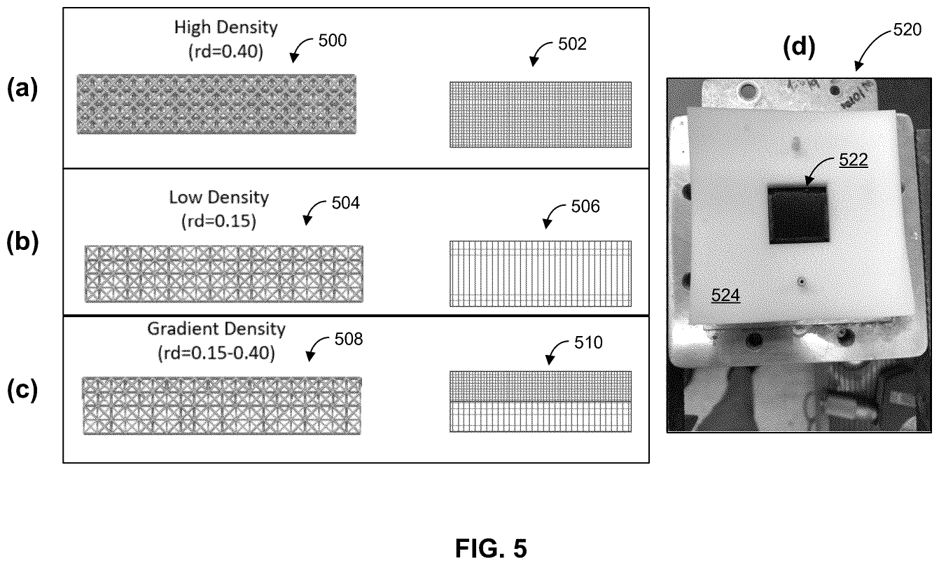

For example, as illustrated in part (a) of FIG. 5 a pattern of features may be engineered to result in a uniform pattern of features of an electrode having a high relative density (RD). The side view 500 of the high-density geometry illustrates the uniform pattern of a plurality of features, and the top down view 502 of the high density geometry illustrates the flow-through pattern having a high density of features.

Part (b) of FIG. 5 illustrates a pattern of features of the electrode engineered to result in a pattern of features of an electrode having a low relative density (RD). The side view 504 illustrates a smaller number of features in a uniform pattern compared to the high density pattern. The top down view 506 of the low density geometry illustrates a flow through pattern having a lower density of features.

Part (c) of FIG. 5 illustrates a gradient pattern of features of an electrode engineered to result in a gradient pattern of features having a portion of the electrode having a higher relative density and a portion of the electrode having a lower relative density. The side view 508 of the gradient pattern illustrates a similar pattern of uniform features compared to the side view 504 of the low density pattern, however, the top down view 510 of the gradient pattern illustrates a higher density of features (resulting in a higher relative density) in one portion of the electrode, and a lower density of features (resulting in a lower relative density) in another portion of the electrode.

Part (d) of FIG. 5 is an image of a top down view of an electrochemical cell 520 having a flow-through electrode 522 positioned in a gasket 524 of the electrochemical cell 520.

In some approaches, the geometries of the 3D printed electrodes may be fabricated according to various parameters to result in predefined physical characteristics of the structure. For example, physical characteristics of the structure may include surface area, surface area per volume, porosity, predicted iron plating, etc. Parameters for forming a specific geometry of an electrode include lengths, average diameters, etc. of features of a geometry that result in a specific surface area of the structure. In one approach, engineering the structure of the electrode allows fabrication of porous electrode having a predefined surface area. For example, defined features of a 3D printed electrode are arranged in different geometries. In one example, an electrode having a defined geometry with a predefined arrangement of features may be used in a redox load battery that includes iron deposition/stripping.

In one approach, a 3D printed electrode may be fabricated using a carbon ink in direct ink writing (DIW) technologies. In another approach, a 3D printed electrode may be fabricated using a polymer resin with a lithography-based printing technique, where the formed electrode structure is carbonized.

According to one embodiment, 3D structures are engineered to enable uniform metal deposition/striping through the electrode that allows the apparatus to maintain about a consistent (e.g., a more even) current distribution across the volumetric surface of the electrode during charging and discharging. The volumetric surface may be defined as a surface area within the porous electrode. A consistent current distribution maintains effective mass transport under dynamic conditions of metal deposition (charging) and stripping (discharging). For example, the apparatus may be configured to maintain about consistent and event current distribution across at least 10 consecutive cycles of charging and discharging cycles, such as across at least 10 consecutive metal depositing/stripping cycles on the electrode surface.

In addition, efficient and smooth metal stripping may be achieved by overcoming the metal cluster dissolution and stripping. Hence, discharging capacity may be improved. Metal cluster dissolution is an erosion process which may occur during charging and discharging process due to loss of adhesion of deposited metal layer/cluster on the electrode. Loss of adhesion due to multiple reasons may cause environmental changes near the electrode such as flow rate fluctuations, gas bubble formation, pH decrease, etc. Similar to the undesirable process of self-discharge, metal cluster dissolution from a charged electrode is undesirable since the metal dissolution occurs without contributing to the electrochemical discharging process. This is an electrochemically uncontrolled process and faradaic efficiency may be lost during metal cluster dissolution. Additively manufactured 3D porous structures may minimize or remove metal cluster erosion.

In some approaches, a flow battery is configured to move electrolyte through the 3D engineered porous electrode structures in contrast to a conventional flow battery with planar electrodes that is configured to move the electrolyte along the outside surface of the electrode. The flow-through electrode structures may be comprised of a combination of conductive and nonconductive materials. In one approach conductive porous structures facilitate electrodeposition reactions during flow battery charging. Then, during discharge, oxidation reactions may occur on the conductive electrode, and metal may be stripped from the electrode structure. In another approach, nonconductive material in the porous structures may help mitigate the clogging of cell components due to metal deposition thereby allowing electrolyte flow within the plating compartment of the flow battery.

According to various approaches, an electrode may be engineered according to a predefined pattern of a flow field. A flow field may be engineered so that the flow of electrolyte is not parallel to the electrode but rather the flow is forced through the electrode. The flow-through approach may be engineered by modifying fields for a flow through set up on time flow. An electrode having engineered flow fields to push the solution through the electrode. The 3D printed electrodes may be designed in a geometric pattern to function as a flow.

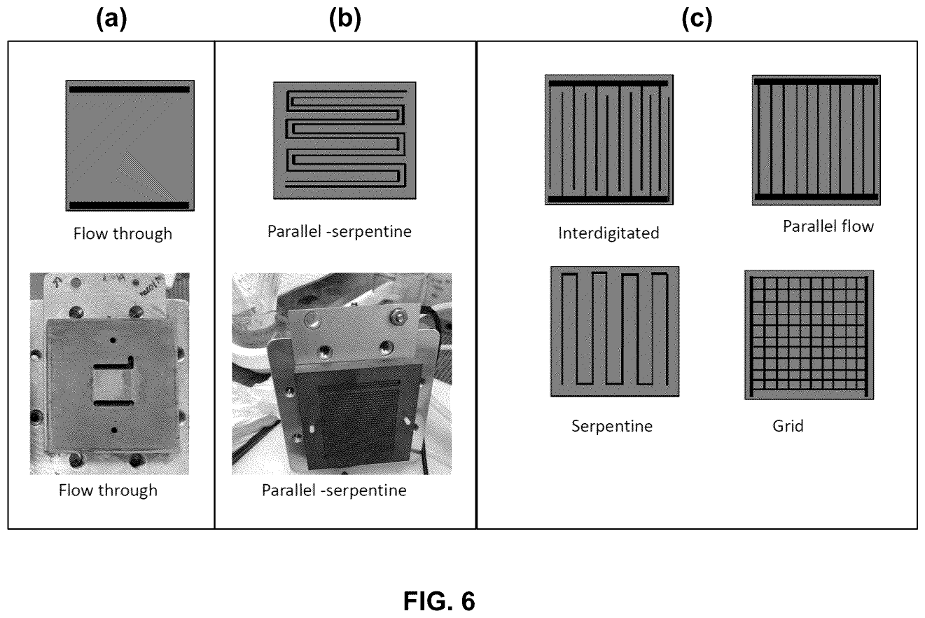

FIG. 6 illustrates various examples of flow fields engineered for flow of electrolyte in the electrochemical cell. Part (a) is an example of a flow-through flow field where the bottom image shows a flow through electrode implemented in an electrochemical field. Part (b) is a parallel serpentine flow field where the bottom image shows the parallel serpentine flow field implemented in an electrochemical cell. Part (c) illustrates various flow fields that may be engineered including an interdigitated flow field, a parallel flow field, a serpentine flow field, and a grid flow field. Therse are by way of example only and are not meant to be limiting in any way.

According to one embodiment, an apparatus includes a redox flow battery. In some approaches, a redox flow battery includes metal deposition. In one example, a redox flow battery is a vanadium redox flow batteries that does not rely on metal deposition. In preferred approaches, a redox flow battery includes metal deposition such as an iron redox flow battery, a zinc redox flow battery, a copper redox flow battery, etc.

Moreover, during operation, the thickness of the electrodes may increase due to the plating the electrode with the metal of the electrolyte (e.g., Fe from the Fe—Cl electrolyte). The electrode with the deposited metal becomes a different structure. An electrode having a gradient density allows a flow distribution throughout the deposition process within a predefined duration of time. For example, the flow distribution throughout the deposition process may be longer, such as within 8 hours, compared to a uniform density electrode having a deposition process within about 4 hours.

According to one embodiment, operation of a hybrid flow battery includes dynamically deviating 3D structural and flow features. According to one approach, an electrode may be improved for a flow-through battery (e.g., hybrid flow battery) that includes metal plating/stripping to achieve superior performance. Designing and manufacturing of higher surface area 3D flow-through electrodes enable achieving higher current densities and higher storage capacity in hybrid flow batteries.

In preferred approaches, the use of 3D printed electrode reduces the rust formation on/inside electrode structures compared to the use of carbon felt electrode during operation of the flow battery. Without wishing to be bound by any theory, it is believed that decreased rust formation may be due to improved flow of electrolyte with 3D printed electrodes. When flow is improved, fresh electrolyte is circulated through the electrode structure at a faster rate. Local concentrations of ions (OH⁻, H⁺, Fe²⁺, FeOH⁺; NH4⁺, Cl⁻, etc.) are different compared to concentrations present during poor flow. Thus, iron-hydroxides and iron oxides (i.e., rust) formation is less with 3D printed electrodes. In addition, the decrease in rust formation may be related to local surface pH since 3D printed electrodes enable lower local pH during charging of the battery. Thus, performance of the electrochemical cell is improved using the 3D printed electrode, even in the presence of some rust formation on the 3D printed structures.

A 3D printed porous electrode demonstrates improvements in stability of performance in an electrochemical cell compared to the same cell using a felt electrode. In studies of cell voltage provides over long term experiments, the stability of the performance over time and multiple cycles is higher with the 3D printed electrode compared to the felt electrode. In one approach measuring voltage efficiency and during cycling, a redox flow battery apparatus having a porous 3D printed electrode as described herein may have a voltage efficiency that is stable (See FIG. 7A). In preferred approaches, engineered 3D electrodes demonstrate better voltaic efficiency independent of stability of the apparatus during greater than 25,000 cycles. Because stability of performance is associated additional factors than the composition and design of the 3D electrode, the maximum degradation over greater than 25,000 may be greater. Degradation of the voltage efficiency may be caused by several issues including: electrolyte, pH, geometry of the electrode, etc. Performance of 3D printed electrodes may be improved by optimizing parameters of the redox flow apparatus.

According to one approach, the redox flow battery apparatus as described herein is configured to maintain a pH value in a range of two consecutive pH values during greater than 5 consecutive cycles of charging/discharging, where the difference between two pH values is a 10-fold difference in acidity. For example, in a preferred approach, the flow apparatus the pH may range from pH 2.5 to pH 3.5 during consecutive cycles of charging and discharging. The pH of the electrolyte may also affect the flow rate of the electrolyte in the electrochemical cell. Deposition on the electrodes may be determined by the pH of the electrolyte. A changing pH in turn affects the flow rate of the electrolyte. Without wishing to be bound by any theory, it is difficult to predict an optimal flow rate because the metal deposition on the electrode depends strongly on pH and pH changes depending on the flow rate, current, etc.

### Experiments

For various experiments described below, materials included cell hardware (Fuel Cell Technologies, Inc), pumps (NKF Simdos 10), membranes Fumasep-FAS 30, Fumasep FAP 450, Nafion 117, and Fumasep FBM PK. Electrolyte includes FeCl₂ and NH₄Cl.

Electrodes included graphite felt, 3D-printed carbonized electrodes using nTopology-lattice modeling.

Electrochemical testing included BioLogic ED-Lab (V11.36) using VSP VMP3B-10 (10 A/20V). pH monitoring included eDAQ Pod-Vu (1.2.4)-Quad pH Amp 168 (EU168) with a Hanna Instrument pH electrode HI1131B glass body.

### Electrode Stability in Terms of Voltaic Efficiency

The plots of FIGS. 7A-7B illustrate the voltaic efficiency of the 3D printed electrodes compared to the felt electrodes. Part (b) of FIG. 7A represents the voltage of an apparatus including a 3D printed electrode (e.g., a log pile structure printed using DIW techniques) having a log-pile geometry across consecutive cycles for 50 hours. In comparison, part (a) represents the voltage of an apparatus including a felt electrode across a similar number of consecutive cycles of charging/discharging. The apparatus including the 3D printed electrode (part (b)) demonstrated higher stability over time compared to the felt electrode (part (a)) which demonstrated a decrease in voltaic efficiency (VE) over time. The conditions of the apparatus were not optimized, and thus, better performance may be predicted using optimized conditions and designs of the printed electrode.

Part (c) illustrates a summary of the voltaic efficiency degradation rate of the apparatuses including the felt electrode and Log Pile DIW electrode calculated from the respective plots in part (a) and (b). The apparatus including the 3D printed electrode (“Log Pile DIW”) demonstrated only a 0.04 degradation rate per cycle compared to the apparatus including the felt electrode that demonstrated a 0.17 degradation rate (a 75% difference). The testing cycles were short-term cycles with one hour charging and one hour discharging.

FIG. 7B illustrates similar voltage efficiency plots of an apparatus that includes a felt electrode (part (a)) and an apparatus that includes a 3D printed electrode (part (b)). Each plot includes a pH curve that represents the measured pH during each consecutive cycle, the pH was monitored from each of the circulating iron electrolyte solution (positive and negative electrolyte solutions). The pH curve from the apparatus including the felt electrode was as high in a range of greater than pH 4.1 for the course of 50 hours whereas the pH curve of from the apparatus including the 3D printed electrode remained within a range of pH 2.6 to 3.1. Without wishing to be bound by any theory, it is believed that the rapid degradation of the performance with felt electrode during multiple cycles may be due in part to a pH increase over time and cell voltage instability. The 3D printed electrodes demonstrate a lower pH and table cell voltage during multiple cycles over time.

### Flow Rate at 50% State of Charge

Table 2 lists flow rate measurements of different electrode structures at 50% state of charge. For a graphite felt electrode having an initial 50 mL/min flow rate, at 4 hours of charging the battery, the flow rate drops to 2 mL/min, equivalent to about a flow rate that is 25 times lower than the initial flow rate. For a 3D printed electrodes, at 4 hours of charging the battery, the flow rate is retained in a battery having a 3D printed octet electrode having flow rate of 34 mL/min flow rate and a battery having a 3D printed gyroid electrode having a flow rate of 20 mL/min. Flow measurements for different 3D printed electrodes. In one example, a flow rate change from an initial rate of 50 mL/min, battery charged for 4 hour flow rate at 2 mL/min, a 3D printed electrode retains a flow rate at 4 hours of 13 mL/min.

TABLE 2
Flow rates according to different electrode structures

| Electrode Type | Flow rate at 50% charge (mL/min) |
|---|---|
| Pump flow rate with no cell | 50 |
| Graphite felt | 2 |
| 3D printed octet | 34 |
| 3D printed gyroid | 20 |

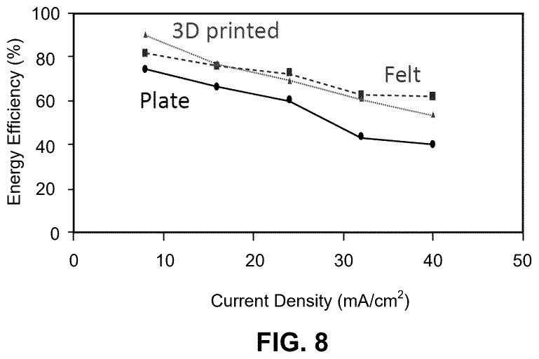

In one approach, baseline performance of a flow battery may be advanced with 3D printed plating electrodes. FIG. 8 depicts a comparison plot of energy efficiency versus current density of different electrochemical cells having different electrodes. The energy efficiency is comparable between the felt electrode (dashed line) to the 3D printed electrode (dotted line), both significantly improved compared to the decrease in energy efficiency of the plate with increased current density.

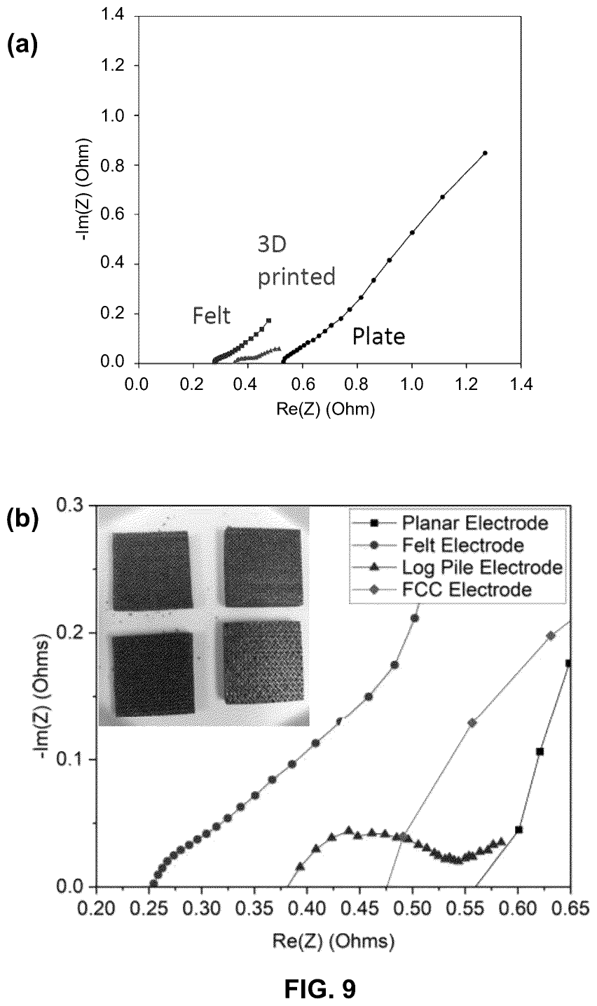

Conductivity of the electrodes was examined in the experiments illustrated in FIG. 9 which depicts a plot of electrochemical impedance spectrophotometry (EIS) results for an electrochemical cell using a membrane, Fumasep FAP-450. Part (a) depicts a large view of the impedance of the electrochemical cells with the three different electrodes, the felt (▪) and 3D printed (▴) electrodes demonstrated better ohmic resistance compared to the plate electrode (●).

Part (b) is a magnified view of the plot, between a scale of 0.20 to 0.65 resistance on the x-axis. The felt carbon electrode (●) having a high surface demonstrates a low resistance. The planar electrode (▪) has the highest resistance, and thus the lowest conductivity of the tested electrodes. The internal resistance of the 3D printed log-pile electrodes (▴) and FCC electrodes (♦) are within the range of the felt electrodes and planar electrodes. The 3D printed carbon electrode measured internal resistance by EIS within the range of the graphite felt and planar electrode. The inset image depicts a series of 3D printed electrodes.

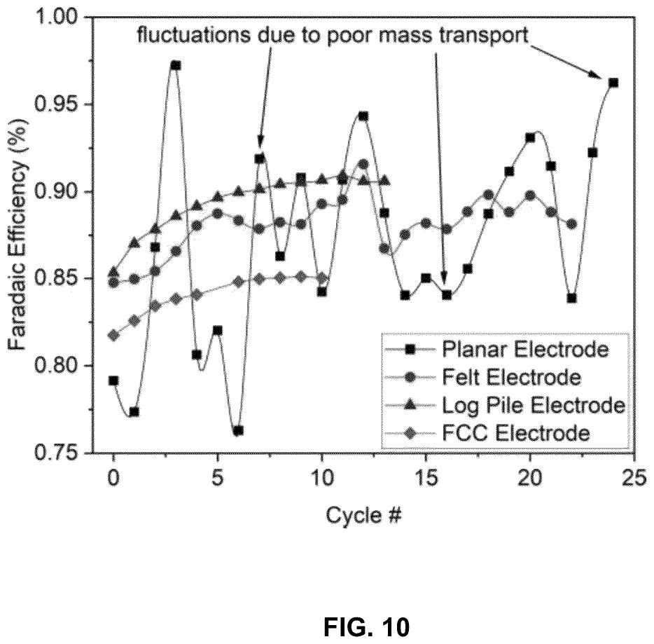

FIG. 10 depicts a plot of faradaic efficiency of a redox flow battery using different electrode structures. During charging of each cycle, the electrodes are plated with iron, and during the discharging step of each cycle, metal is stripped off. The 3D printed log-pile electrodes (▴) demonstrated capability of producing higher faradaic efficiencies compared to either felt electrodes (●), or 3D printed FCC electrodes (♦), or the planar electrodes (▪). Both planar and felt electrodes demonstrated fluctuations in faradaic efficiency over time due to uncontrolled and poor mass transport and erosion. 3D printed electrodes demonstrate a stable performance of multiple cycles.

For application of using a 3D printed electrode in batteries, a battery having a 3D printed electrode has improved capacity over a longer period of time compared to a battery having a felt electrode. For example, the plot in FIG. 11 shows the charging and discharging curves over 8 hours for the different batteries over 8 hours. The plot illustrates the capacity curves of charging and discharging an electrochemical cell having a felt electrode (solid line) and an electrochemical cell having a 3D printed electrode (●) from an 8 hr long-duration cycle at 25 mA/cm². The results show an 8.5% increase in discharging capacity for the 3D printed octet electrode (●) compared to the felt electrode. The favorable results of the 3D printed octet electrode may be due to a higher mass flow and more even flow distribution in the electrochemical cell due to the 3D printed octet electrode.

### In Use

Various aspects of the embodiments described herein may be used for hybrid redox flow batteries, bulk metal depositing electrochemical systems, etc.

The inventive concepts disclosed herein have been presented by way of example to illustrate the myriad features thereof in a plurality of illustrative scenarios, aspects of an inventive concept, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects of an inventive concept have been described above, it should be understood that they have been presented by way of example only, and not limitation. Thus, the breadth and scope of an aspect of an inventive concept of the present invention should not be limited by any of the above-described exemplary aspects of an inventive concept but should be defined only in accordance with the following claims and their equivalents.

What is claimed is:

1. A redox flow battery apparatus, comprising:
a membrane;
a flow plate; and
a porous electrode positioned between the membrane and the flow plate,
wherein the porous electrode has a surface configured for a reversible metal deposition thereon from a metal ion electrolyte solution flowing through the porous electrode,
wherein the porous electrode has a predefined porosity configured to allow the flowing of the metal ion electrolyte solution through the porous electrode.

2. The redox flow battery apparatus as recited in claim 1, further comprising a second flow plate; and
a second porous electrode positioned between the membrane and the second flow plate.

3. The redox flow battery apparatus as recited in claim 1, wherein the metal ion electrolyte solution includes a metal selected from the group consisting of: iron, copper, lead, tin, and zinc.

4. The redox flow battery apparatus as recited in claim 1, wherein the porous electrode is configured to promote homogenous flow of the metal ion electrolyte solution through the porous electrode.

5. The redox flow battery apparatus as recited in claim 1, wherein the porous electrode is configured as a flow field plate.

6. The redox flow battery apparatus as recited in claim 1, wherein the porous electrode and the flow plate are fabricated as a single structure.

7. The redox flow battery apparatus as recited in claim 1, wherein the redox flow battery apparatus is configured, during charging or discharging, to maintain a flow rate of the metal ion electrolyte solution at greater than 40% of a flow rate measured at 0% charge when the redox flow battery apparatus is at 50% charge.

8. The redox flow battery apparatus as recited in claim 1, wherein the reversible metal deposition includes metal deposition onto surfaces of pores of the porous electrode during charging and metal stripping from the surfaces of the pores of the porous electrode during discharging.

9. The redox flow battery apparatus as recited in claim 1, wherein an extent of metal deposition is reproducible for at least 10 consecutive cycles of charging and discharging.

10. The redox flow battery apparatus as recited in claim 1, wherein the porous electrode is configured to achieve a predefined level of storage capacity across at least 5 consecutives cycles of charging and discharging.

11. The redox flow battery apparatus as recited in claim 1, wherein the apparatus is a hybrid flow apparatus.

12. The redox flow battery apparatus as recited in claim 1, wherein the porous electrode includes a material selected from the group consisting of: carbon, stainless steel, copper, zinc, and titanium.

13. The redox flow battery apparatus as recited in claim 1, wherein the porous electrode is a three-dimensional printed structure.

14. The redox flow battery apparatus as recited in claim 1, wherein the porous electrode includes an ordered structure, wherein the ordered structure includes a repeating shape geometry selected from the group consisting of: a cubic, an octet, a gyroid, and a diamond.

15. The redox flow battery apparatus as recited in claim 14, wherein the shape geometry comprises repeating units, wherein each unit has an average diameter in a range of 100 nanometers to about 10 millimeters.

16. The redox flow battery apparatus as recited in claim 1, wherein the porous electrode has a predefined porosity in a range of greater than 0.05 to less than 0.95, wherein porosity is defined as a pore volume relative to total volume of the porous electrode.

17. The redox flow battery apparatus as recited in claim 1, wherein the porous electrode is a gradient density electrode, wherein the porous electrode has regions of differing relative density, wherein a first region of the gradient density electrode has a relatively lower density, and a second region of the gradient density electrode has a relatively higher density.

18. The redox flow battery apparatus as recited in claim 1, wherein the apparatus is configured to maintain about a consistent current distribution across a volumetric surface of the electrode during at least 10 consecutive cycles of charging and discharging, wherein the volumetric surface is defined as the surface area within the electrode structure.

19. The redox flow battery apparatus as recited in claim 1, wherein the porous electrode is configured to exhibit in a bulk metal deposition up to about 7.5 grams/cm³ of total volume of the porous electrode during charging and a stripping of about 98% of the deposited metal during discharging.

20. The redox flow battery apparatus as recited in claim 1, comprising a three-dimensional porous structure that is nonconductive, wherein the porous electrode is electrically conductive, wherein the three-dimensional porous structure is positioned between the membrane and the porous electrode.
